(19) United States
(12) Patent Application Publication
(10) Pub. No.: US 2026/0147288 A1
(43) Pub. Date: May 28, 2026

(54) IMAGE FORMING APPARATUS

(71) Applicant: KYOCERA Document Solutions Inc., Osaka (JP)

(72) Inventors: Teruhiko NAGASHIMA, Osaka (JP); Koji TANIO, Osaka (JP)

(73) Assignee: KYOCERA Document Solutions Inc., Osaka (JP)

(21) Appl. No.: 19/390,050

(22) Filed: Nov. 14, 2025

(30) Foreign Application Priority Data
Nov. 22, 2024 (JP) 2024-203610

(51) Int. Cl. G03G 15/01; G03G 21/16

(52) U.S. Cl. CPC G03G 15/0121; G03G 15/0189; G03G 21/1633; G03G 21/1647; G03G 2221/1654

(57) ABSTRACT

An image forming apparatus includes a plurality of containers, a plurality of first actuators, a second actuator, a plurality of first biasing members and a second biasing member. In a state where each of the first actuators is in a first non-fitting position, the first actuator presses the second actuator to cause the second actuator to remain in a second non-fitting position whereas in a state where each of the first actuators is in a first fitting position, the first actuator releases the pressing of the second actuator. The biasing force of one of the first biasing members is greater than the biasing force of the second biasing member.

### INCORPORATION BY REFERENCE

This application is based upon and claims the benefit of priority from the corresponding Japanese Patent Application No. 2024-203610, filed on Nov. 22, 2024, the entire contents of which are incorporated herein by reference.

### BACKGROUND

The present disclosure relates to an image forming apparatus including a plurality of containers which store toners.

A conventional image forming apparatus uses a toner in a container to perform printing. In a color image forming apparatus, a plurality of containers are fitted into the main body of the image forming apparatus. The containers correspond to cyan, magenta, yellow and black, and store the toners of the corresponding colors.

### SUMMARY

An image forming apparatus according to an aspect of the present disclosure includes a main body, a plurality of containers, a plurality of first actuators, a second actuator, a plurality of first biasing members, a second biasing member and a detection unit. The main body includes a printing unit. Each of the plurality of containers is individually removably fitted into the main body, and stores a toner used in printing performed in the printing unit. The plurality of first actuators are supported to be turnable around a first axis independently of each other with respect to the main body, and are respectively allocated to the plurality of containers, and each of the plurality of first actuators makes contact with, when a corresponding one of the containers is fitted into the main body, the corresponding container, and turns around the first axis to be displaced from a first non-fitting position to a first fitting position. The second actuator is supported to be turnable around a second axis parallel to the first axis with respect to the main body, and turns around the second axis to be displaceable from a second non-fitting position to a second fitting position. The plurality of first biasing members are respectively allocated to the plurality of first actuators, and each of the plurality of first biasing members biases a corresponding one of the first actuators in a direction from the first fitting position toward the first non-fitting position. The second biasing member biases the second actuator in a direction from the second non-fitting position toward the second fitting position. The detection unit changes an output value depending on whether the second actuator is in the second non-fitting position or in the second fitting position. In a state where each of the plurality of first actuators is in the first non-fitting position, the first actuator presses, by a biasing force of a corresponding one of the first biasing members, the second actuator against a biasing force of the second biasing member in a direction from the second fitting position toward the second non-fitting position to cause the second actuator to remain in the second non-fitting position. In a state where each of the plurality of first actuators is in the first fitting position, the first actuator releases the pressing of the second actuator in the direction from the second fitting position toward the second non-fitting position. The biasing force of one of the plurality of first biasing members is greater than the biasing force of the second biasing member.

### BRIEF DESCRIPTION OF THE DRAWINGS

FIG. 1 is a perspective view of an image forming apparatus according to an embodiment;

FIG. 2 is a perspective view in a state where one of outer covers in the image forming apparatus shown in FIG. 1 is in an open position;

FIG. 3 is a schematic view showing the internal configuration of the image forming apparatus according to the embodiment;

FIG. 4 is a schematic view of an image formation unit in the image forming apparatus shown in FIG. 3 and an area around the image formation unit;

FIG. 5 is a perspective view of a container which is fitted into the main body of the image forming apparatus according to the embodiment;

FIG. 6 is a perspective view of the container which is fitted into the main body of the image forming apparatus according to the embodiment;

FIG. 7 is a perspective view of the container which has been fitted into the outer cover in the image forming apparatus according to the embodiment and an area around the container;

FIG. 8 is a schematic view showing a positional relationship between the container and an inner cover in a state where the outer cover in the image forming apparatus according to the embodiment is in the open position;

FIG. 9 is a schematic view showing a positional relationship between the container and the inner cover in a state where the outer cover in the image forming apparatus according to the embodiment is in a closed position;

FIG. 10 is a schematic view of a detection mechanism in the image forming apparatus according to the embodiment (in a state where a detection region is light-shielded);

FIG. 11 is a schematic view of the detection mechanism in the image forming apparatus according to the embodiment (in a state where the detection region is opened);

FIG. 12 is a perspective view of a first actuator in the image forming apparatus according to the embodiment;

FIG. 13 is a perspective view of a second actuator in the image forming apparatus according to the embodiment;

FIG. 14 is a schematic view showing a positional relationship between each of the first actuators and the second actuator in a state where no containers are fitted into the image forming apparatus according to the embodiment;

FIG. 15 is a schematic view showing a positional relationship between each of the first actuators and the second actuator in a state where one container is fitted into the image forming apparatus according to the embodiment;

FIG. 16 is a schematic view showing a positional relationship between each of the first actuators and the second actuator in a state where two containers are fitted into the image forming apparatus according to the embodiment;

FIG. 17 is a schematic view showing a positional relationship between each of the first actuators and the second actuator in a state where three containers are fitted into the image forming apparatus according to the embodiment; and

FIG. 18 is a schematic view showing a positional relationship between each of the first actuators and the second actuator in a state where all the containers are fitted into the image forming apparatus according to the embodiment.

### DETAILED DESCRIPTION

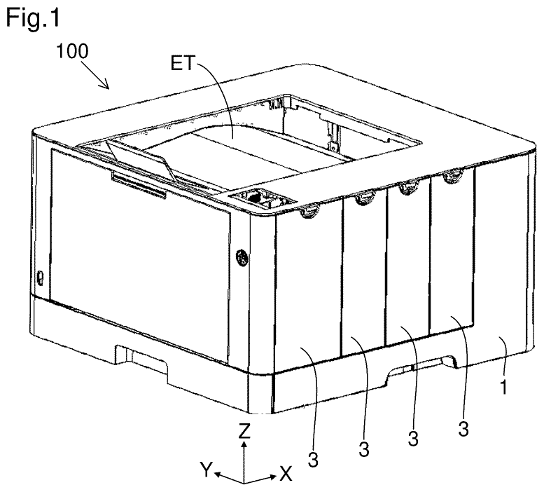

An image forming apparatus 100 in the present embodiment will be described below with reference to FIGS. 1 to 18. The image forming apparatus 100 is installed on a substantially horizontal, flat floor surface FL. A vertical direction perpendicular to the floor surface FL is an up/down direction in the image forming apparatus 100. One of horizontal directions is a forward/backward direction in the image forming apparatus 100, and the other direction orthogonal to the one direction is a left/right direction in the image forming apparatus 100.

In the drawings referenced in the following description, for ease of understanding, an XYZ Cartesian coordinate system is shown. A Z direction is the vertical direction which is the up/down direction in the image forming apparatus 100. The floor surface FL is a surface which is perpendicular to the Z direction. A direction indicated by the arrow of the Z direction is an upward direction, and a direction opposite thereto is a downward direction.

An X direction is one of the horizontal directions, and a Y direction is the other of the horizontal directions. For example, the X direction corresponds to the forward/backward direction in the image forming apparatus 100. The Y direction corresponds to the left/right direction in the image forming apparatus 100.

### Configuration of Image Forming Apparatus

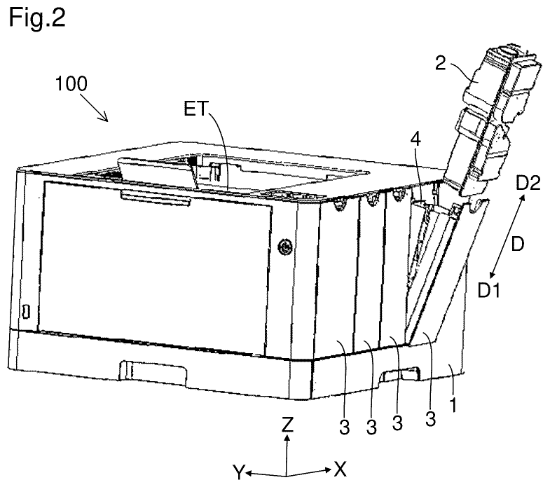

As shown in FIGS. 1 and 2, the image forming apparatus 100 includes a main body 1. The image forming apparatus 100 also includes containers 2. The containers 2 store toners used in printing. The containers 2 are fitted into the main body 1. The number of containers 2 fitted is four. The (four) containers 2 correspond to cyan, magenta, yellow and black. In the containers 2, the toners corresponding to the colors are stored.

The containers 2 are individually removable from the main body 1. A user manually performs a fitting/removal operation on each of the containers 2. For example, when any one of the containers 2 is empty, the empty container 2 is removed, and a new container 2 is fitted.

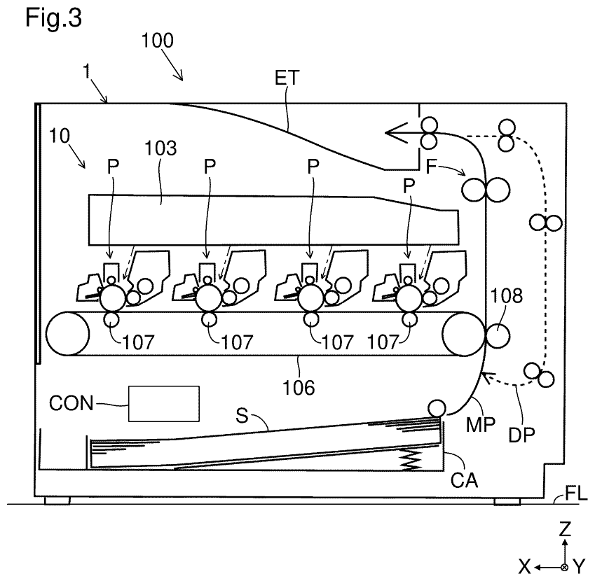

As shown in FIG. 3, the main body 1 includes a printing unit 10. The printing unit 10 prints an image on a sheet S. The sheets S used in printing are stored in a sheet cassette CA. The sheet cassette CA is removably fitted into the main body 1.

The printing unit 10 includes a main conveyance path MP. The main conveyance path MP extends through a transfer position and a fixing position in this order, and reaches an ejection tray ET.

In the printing performed by printing unit 10, the sheet S in the sheet cassette CA is supplied to the main conveyance path MP, and the sheet S is conveyed along the main conveyance path MP. An image is formed using the toners. Then, the image is printed on the sheet S being conveyed. In other words, transfer processing (specifically, secondary transfer) for the image on the sheet S being conveyed is performed in the transfer position. In the fixing position, fixing processing for the image on the sheet S is performed.

The printing unit 10 includes four image formation units P corresponding to the colors of cyan, magenta, yellow and black. Each of the image formation units P uses the toner of the corresponding color to form an image.

Although attention is focused on one of the image formation units P, and its configuration will be described below, the configurations of the image formation units P are the same as each other. Hence, the following description can be used for the description of the configurations of the other image formation units P, and thus the description is omitted.

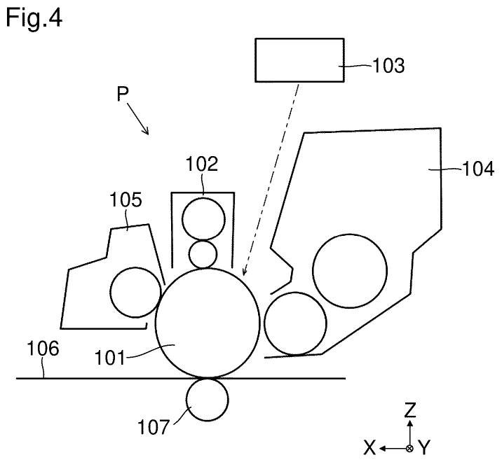

The image formation unit P has the configuration as shown in FIG. 4. The image formation unit P includes a photosensitive drum 101, a charging device 102, an exposure device 103, a development device 104 and a cleaning device 105.

The photosensitive drum 101 is supported rotatably around an axis extending in the left/right direction (Y direction). The photosensitive drum 101 is rotated while carrying a toner image on its outer circumferential surface. The charging device 102 charges the outer circumferential surface of the photosensitive drum 101. The exposure device 103 exposes the outer circumferential surface of the photosensitive drum 101 to form an electrostatic latent image on the outer circumferential surface of the photosensitive drum 101. The development device 104 receives the supply of the toner from the container 2 which stores the toner of the corresponding color. The development device 104 uses the toner to develop the electrostatic latent image on the outer circumferential surface of the photosensitive drum 101 into the toner image. The cleaning device 105 removes the toner left on the outer circumferential surface of the photosensitive drum 101.

As shown in FIG. 3, the printing unit 10 includes an intermediate transfer belt 106. The intermediate transfer belt 106 is a seamless belt. The intermediate transfer belt 106 is stretched on a plurality of tension rollers (the symbols of which are omitted).

The intermediate transfer belt 106 is disposed such that its outer circumferential surface is in contact with the outer circumferential surface of each of the photosensitive drums 101. On the outer circumferential surface of the intermediate transfer belt 106, the toner images on the outer circumferential surfaces of the photosensitive drums 101 are primarily transferred. The intermediate transfer belt 106 is rotated while carrying the toner images on its outer circumferential surface. In this way, the toner images on the outer circumferential surface of the intermediate transfer belt 106 are conveyed toward the transfer position.

The printing unit 10 includes primary transfer rollers 107. The four primary transfer rollers 107 are provided. The primary transfer rollers 107 are allocated to the photosensitive drums 101, respectively.

The printing unit 10 includes a secondary transfer roller 108. The secondary transfer roller 108 is pressed against the outer circumferential surface of the intermediate transfer belt 106 in the transfer position, and forms a transfer nip between the intermediate transfer belt 106 and the secondary transfer roller 108. The main conveyance path MP extends via the transfer nip.

In a print job, the sheet S is conveyed toward the transfer position (that is, the transfer nip). Each of the image formation units P uses the toner of the corresponding color to form the toner image. The primary transfer rollers 107 primarily transfer the toner images to the outer circumferential surface of the intermediate transfer belt 106. The intermediate transfer belt 106 is rotated while carrying the toner images. The secondary transfer roller 108 secondarily transfers the toner images to the sheet S which is being passed through the transfer position.

The image forming apparatus 100 includes a fixing unit F. The fixing unit F includes a heating roller and a pressure roller. The heating roller incorporates a heater. The pressure roller is pressed against the heating roller. The heating roller and the pressure roller are pressed against each other to form a fixing nip in the fixing position.

In the print job, the sheet S is passed through the fixing position (that is, the fixing nip). The fixing unit F heats the sheet S being passed through the fixing position, and pressurizes the sheet S. The fixing unit F heats and pressurizes the sheet S to fix the toner images on the sheet S. The sheet S on which the fixing processing has been performed is ejected to the ejection tray ET.

The image forming apparatus 100 includes a double-sided printing conveyance path DP. In this way, the image forming apparatus 100 can perform not only a single-sided print job for printing an image on only one side of the sheet S but also a double-sided print job for printing images on both sides of the sheet S.

The double-sided printing conveyance path DP branches from the main conveyance path MP in a branch position on a downstream side of the main conveyance path MP in a sheet conveyance direction with respect to the fixing position. The double-sided printing conveyance path DP merges into the main conveyance path MP in a merging position on an upstream side of the main conveyance path MP in the sheet conveyance direction with respect to the transfer position.

When a job to be performed is the single-sided print job, the sheet S is passed through the transfer position only once, and the transfer processing is performed on the sheet S being passed through the transfer position. Then, after the first transfer processing, the sheet S is ejected to the ejection tray ET without being processed.

When a job to be performed is the double-sided print job, the transfer processing is performed once on each of the front and back sides of the sheet S, and thus the sheet S is passed through the transfer position twice. Specifically, when the sheet S is passed through the transfer position for the first time, the transfer processing is performed on one side of the sheet S. After the first transfer processing, the sheet S is switched back after the back end of the sheet S is passed through the branch position and before the sheet S is completely ejected to the ejection tray ET. In this way, the sheet S is drawn from the back end into the double-sided printing conveyance path DP.

Thereafter, the sheet S is conveyed along the double-sided printing conveyance path DP, and the sheet S is returned from the merging position to the main conveyance path MP. In this way, the sheet S is passed through the transfer position again. Here, the orientation of the front and back sides of the sheet S is reversed from the orientation when the sheet S was passed through the transfer position the previous time. Consequently, when the sheet S is passed through the transfer position for the second time, the transfer processing is performed on the other side of the sheet S opposite to the one side of the sheet S.

### Mechanism for Holding Container

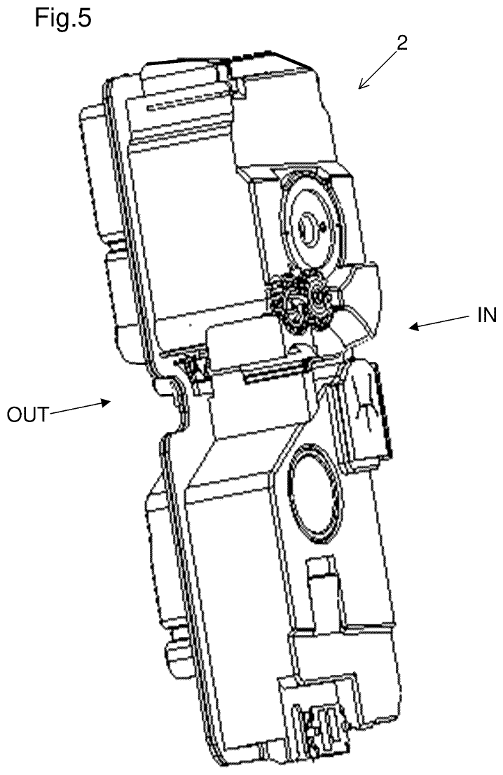

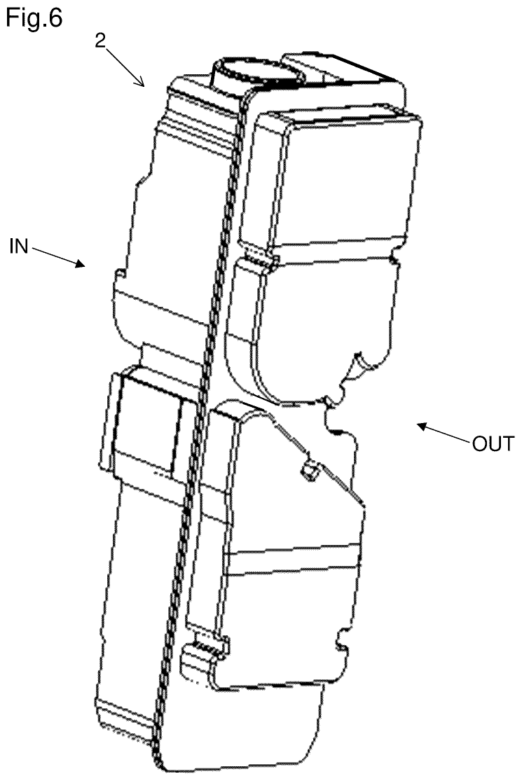

The container 2 has a configuration as shown in FIGS. 5 and 6. The side of the container 2 indicated by an arrow IN is directed to the inside of the main body 1, and the side of the container 2 indicated by an arrow OUT is directed to the outside of the main body 1. The basic configurations of the containers 2 are the same as each other. The capacity of the container 2 for storing the toner of black may be larger than the capacities of the containers 2 for storing the toners of the other colors.

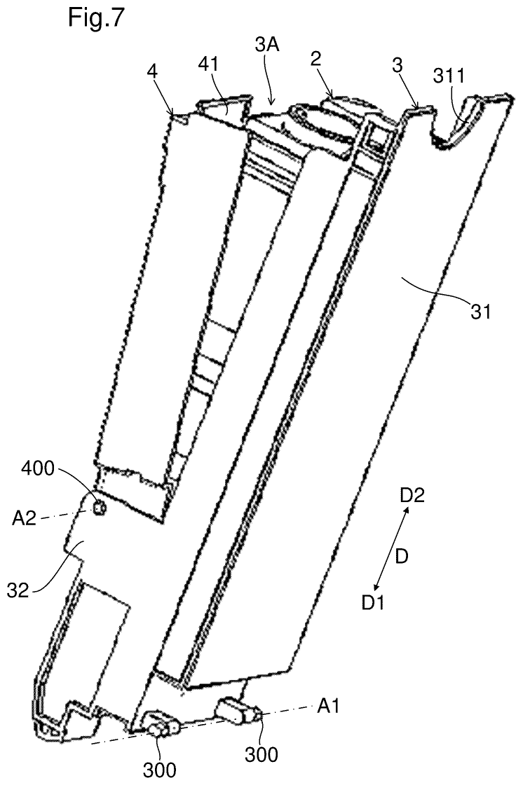

In order to hold the container 2, a mechanism as shown in FIG. 7 is used. The container 2 is held by an outer cover 3 and an inner cover 4. In other words, the image forming apparatus 100 includes the outer cover 3 and the inner cover 4. The outer cover 3 corresponds to a “cover”.

The mechanism shown in FIG. 7 is provided to each of the containers 2. In other words, the outer cover 3 is provided to each of the containers 2. The inner cover 4 is also provided to each of the containers 2.

The outer cover 3 is made of resin. The outer cover 3 may be made of sheet metal. The outer cover 3 is a part of an exterior which covers the interior of the main body 1 from an outer side. In other words, the outer cover 3 includes an exterior surface 31.

The outer cover 3 is attached to the main body 1 to be openable and closable. When the user performs the fitting/removal operation on the container 2, the outer cover 3 is manually opened and closed. For example, the outer cover 3 includes, as a handle 311, a part which is cut downward from the upper edge of the exterior surface 31. When the outer cover 3 is opened or closed, a finger of the user is placed on the handle 311.

The outer cover 3 is supported turnably around an outer cover axis A1 with respect to the main body 1. The outer cover 3 is turned around the outer cover axis A1 to be opened and closed. The outer cover axis A1 is an axis extending in the forward/backward direction (X direction). In other words, the outer cover axis A1 is an axis orthogonal to the up/down direction. The outer cover axis A1 corresponds to a “predetermined axis”.

The outer cover 3 includes a pair of support pins 300. The pair of support pins 300 are disposed on the outer cover axis A1, and extend in the axial direction of the outer cover axis A1. On the other hand, the main body 1 includes a pair of support holes though the pair of support holes are not shown in the figure. The pair of support holes in the main body 1 are disposed on the outer cover axis A1, and are opened in the axial direction of the outer cover axis A1. The pair of support pins 300 are fitted into the pair of support holes in the main body 1. The pair of support pins 300 are slidable around the outer cover axis A1 relative to the support holes into which the pair of support pins 300 are fitted. In this way, the outer cover 3 can be turned with the outer cover axis A1 serving as a support point.

The outer cover 3 includes a fitting region 3A on the back surface side of the exterior surface 31 (that is, the inner side of the main body 1). The container 2 is fitted into the fitting region 3A. The container 2 is removable from the fitting region 3A. The outer cover 3 is displaced around the outer cover axis A1, and thus it is possible to cause the outer cover 3 to reach positions in which the container 2 can be fitted and removed.

Specifically, the outer cover 3 is turned around the outer cover axis A1 to be displaceable between an open position and a closed position. The outer cover 3 is brought into a state where the outer cover 3 is opened in the open position, and is brought into a state where the outer cover 3 is closed in the closed position.

In a state where the outer cover 3 is in the closed position, the interior of the main body 1 is covered by an outer side. The fitting region 3A is placed inside the main body 1. In other words, the container 2 in the fitting region 3A is fitted inside the main body 1. Then, the container 2 fitted inside the main body 1 is covered by the outer cover 3 from the outer side of the main body 1.

In the state where the outer cover 3 is in the closed position (that is, in the state where the container 2 is fitted inside the main body 1), the container 2 is located inside the main body 1. The container 2 is connected to the development device 104 via a toner distribution path (not shown). In this way, it is possible to supply the toner from the container 2 to the development device 104.

In a state where the outer cover 3 is in the open position, the interior of the main body 1 is exposed. The fitting region 3A is exposed to the outside of the main body 1. In other words, the container 2 in the fitting region 3A is exposed to the outside of the main body 1. In this way, the container 2 is removable from the fitting region 3A. When the outer cover 3 is in the open position, the container 2 is removable from the fitting region 3A.

A rotation angle between the open position and the closed position of the outer cover 3 about the outer cover axis A1 is less than 90°, and the outer cover 3 cannot be opened when the rotation angle is equal to or greater than 90°. Hence, the direction of fitting/removal D of the container 2 relative to the fitting region 3A is inclined with respect to the up/down direction and the horizontal direction. In other words, when the container 2 is fitted into the fitting region 3A, the container 2 is moved diagonally downward (in the direction of fitting D1). When the container 2 is removed from the fitting region 3A, the container 2 is moved diagonally upward (in the direction of removal D2).

The inner cover 4 is made of resin. The inner cover 4 may be made of sheet metal. The inner cover 4 covers the container 2 in the fitting region 3A from the inner side of the main body 1. In a state where the container 2 is fitted into the fitting region 3A, the container 2 is covered by the outer cover 3 from the outer side of the main body 1, and is covered by the inner cover 4 from the inner side of the main body 1. In other words, the container 2 is disposed between the outer cover 3 and the inner cover 4. Furthermore, in other words, a region between the outer cover 3 and the inner cover 4 is the fitting region 3A.

The inner cover 4 is supported turnably around an inner cover axis A2 with respect to the outer cover 3. The inner cover axis A2 is an axis extending in the forward/backward direction (X direction). In other words, the inner cover axis A2 is an axis parallel to the outer cover axis A1.

The inner cover 4 includes a pair of support pins 400. The pair of support pins 400 are disposed on the inner cover axis A2, and extend in the axial direction of the inner cover axis A2. On the other hand, the outer cover 3 includes a pair of support holes (the symbols of which are omitted). The pair of support holes in the outer cover 3 are disposed on the inner cover axis A2, and are opened in the axial direction of the inner cover axis A2. In the outer cover 3, the support holes are respectively formed in a pair of side walls 32 opposite each other in the forward/backward direction. The pair of support pins 400 are fitted into the pair of support holes in the outer cover 3. The pair of support pins 400 are slidable around the inner cover axis A2 relative to the support holes into which the pair of support pins 400 are fitted. In this way, the inner cover 4 can be turned with the inner cover axis A2 serving as a support point.

The inner cover 4 sandwiches, inside the main body 1, the container 2 in the fitting region 3A, between the outer cover 3 and an upper part 41 located above the inner cover axis A2. In the following description, the upper part 41 of the inner cover 4 is referred to as the inner cover upper part 41. The inner cover upper part 41 is displaced in conjunction with the turning of the outer cover 3 around the outer cover axis A1. In other words, the inner cover upper part 41 is displaced according to the position of the outer cover 3.

Specifically, the image forming apparatus 100 includes a torsion coil spring (not shown). The torsion coil spring is disposed in at least one of the pair of support pins 400. In other words, the torsion coil spring is disposed on the inner cover axis A2. Although not shown in the figure, one arm of the torsion coil spring engages with the outer cover 3, and the other arm engages with the inner cover 4. The inner cover 4 is biased by the biasing force of the torsion coil spring in a direction in which the inner cover upper part 41 is moved away from the outer cover 3.

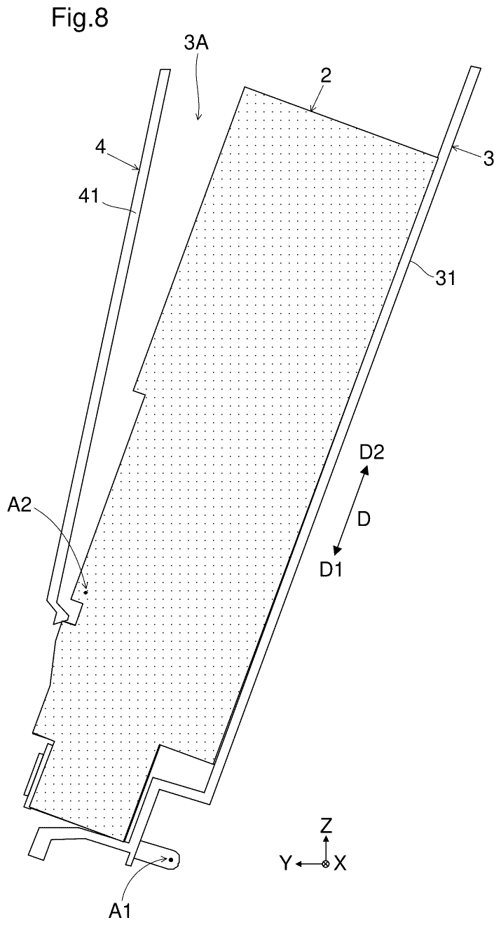

In the state where the outer cover 3 is in the open position, as shown in FIG. 8, the inner cover upper part 41 is moved away from the outer cover 3 to the maximum extent by the biasing force of the torsion coil spring 5. In other words, the fitting region 3A is opened. In this way, the container 2 is removable from the fitting region 3A.

When the container 2 is fitted into or removed from the fitting region 3A, the user moves the container 2 in the direction of fitting/removal D. Here, the inner cover upper part 41 functions as a guide. The inner cover upper part 41 guides the movement of the container 2 in the direction of fitting/removal D. When the container 2 is fitted into the fitting region 3A, the user closes the outer cover 3. In other words, the outer cover 3 is turned from the open position to the closed position.

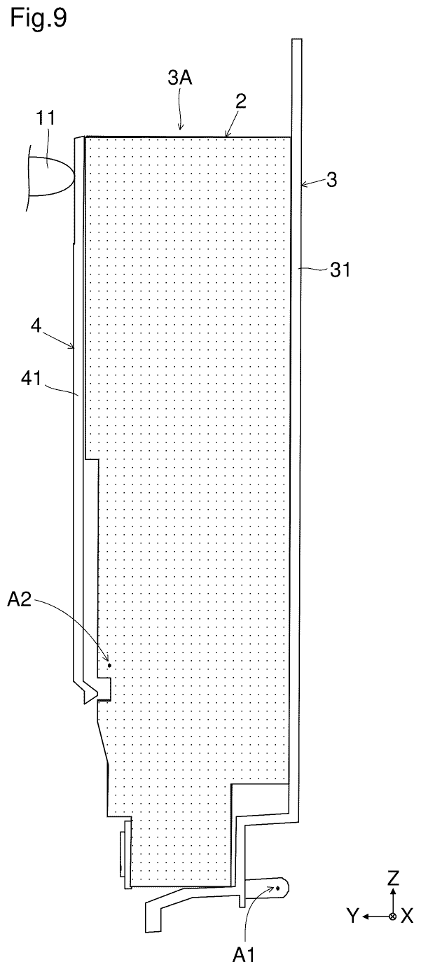

When the outer cover 3 is turned from the open position toward the closed position, and thus the inner cover upper part 41 enters the main body 1, a main body member 11 (see FIG. 9) disposed inside the main body 1 makes contact with the inner cover upper part 41. Thereafter, when the outer cover 3 continues to be turned from the open position toward the closed position, the main body member 11 presses the inner cover upper part 41 from the inner side of the main body 1 to the outer side thereof. Here, the inner cover upper part 41 is turned around the inner cover axis A2, and thus the inner cover upper part 41 is displaced against the biasing force of the torsion coil spring in a direction in which the inner cover upper part 41 approaches the container 2 in the fitting region 3A.

In the state where the outer cover 3 is in the closed position, as shown in FIG. 9, the pressing of the inner cover upper part 41 performed by the main body member 11 is maintained. In this way, the container 2 in the fitting region 3A is sandwiched between the outer cover 3 and the inner cover upper part 41.

When in the state shown in FIG. 9, the outer cover 3 is turned toward the open position, the inner cover upper part 41 is turned around the outer cover axis A1 together with the outer cover 3, and thus the inner cover upper part 41 is displaced in a direction in which the inner cover upper part 41 is moved away from the main body member 11. Finally, the contact between the main body member 11 and the inner cover upper part 41 is released. Furthermore, the inner cover upper part 41 is turned around the inner cover axis A2 by the biasing force of the torsion coil spring, and thus the inner cover upper part 41 is displaced in the direction in which the inner cover upper part 41 is moved away from the outer cover 3. This results in a state shown in FIG. 8.

Here, the four outer covers 3 corresponding to the four containers 2 of cyan, magenta, yellow and black are displaceable independently of each other between the open position and the closed position. Each of the outer covers 3 reaches the closed position from the open position in a state where the corresponding container 2 is fitted inside the fitting region 3A thereof to bring the corresponding container 2 into a state where corresponding container 2 is fitted inside the main body 1.

In FIGS. 8 and 9, a dot pattern is provided to the container 2 to clarify the container 2.

### Detection Mechanism of Containers

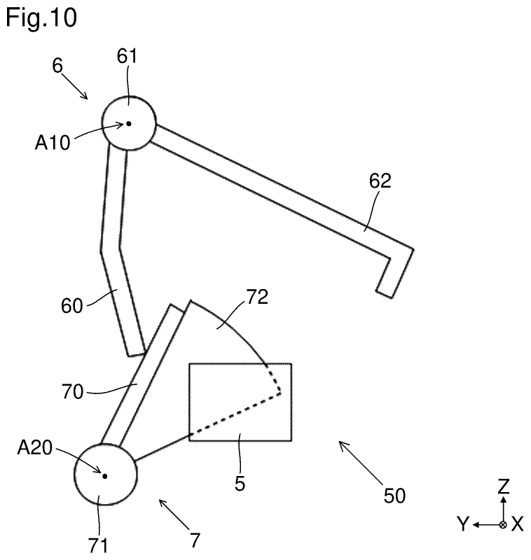

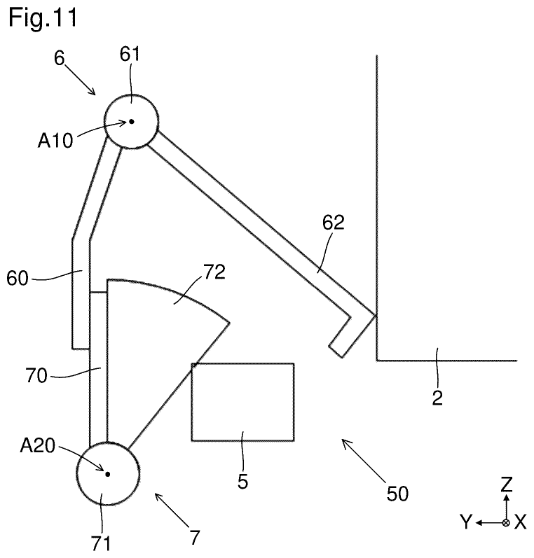

The image forming apparatus 100 includes a detection mechanism 50 as shown in FIGS. 10 and 11. The detection mechanism 50 is a mechanism for detecting the state of fitting of the four containers 2 of cyan, magenta, yellow and black inside the main body 1. When the containers 2 of all the colors are fitted inside the main body 1, information thereof is detected by the detection mechanism 50. When the container 2 of a certain color is fitted inside the main body 1, and the containers 2 of the other colors are not fitted inside the main body 1, information thereof is detected by the detection mechanism 50. When the containers 2 of all the colors are not fitted inside the main body 1, information thereof is detected by the detection mechanism 50.

The detection mechanism 50 includes a detection unit 5. As the detection unit 5, an optical sensor, a switch and the like can be used. For example, the detection unit 5 is a transmission-type optical sensor which includes a light emission portion and a light reception portion.

The detection unit 5 outputs a value corresponding to the state of fitting of the containers 2 inside the main body 1. In other words, the detection unit 5 changes its output value according to the state of fitting of the containers 2 inside the main body 1.

The detection unit 5 is connected to a control unit CON (see FIG. 3). The control unit CON includes a CPU, a memory and the like. The control unit CON is included in the image forming apparatus 100 to control the image forming apparatus 100. The control unit CON detects, based on the output value of the detection unit 5, the state of fitting of the containers 2 inside the main body 1.

Specifically, when all the containers 2 are fitted inside the main body 1, the detection unit 5 outputs a first level value. On the other hand, when any one of the containers 2 is not fitted inside the main body 1, the detection unit 5 outputs a second level value different from the first level value.

When the output value of the detection unit 5 is the first level value, the control unit CON allows the image forming apparatus 100 to perform printing. On the other hand, when the output value of the detection unit 5 is the second level value, the control unit CON does not allow the image forming apparatus 100 to perform printing. For example, when the output value of the detection unit 5 is the second level value, the control unit CON displays a message indicating that any one of the containers 2 is not fitted on an operation panel in the image forming apparatus 100.

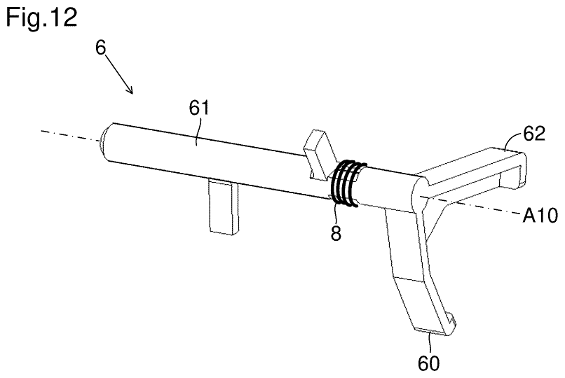

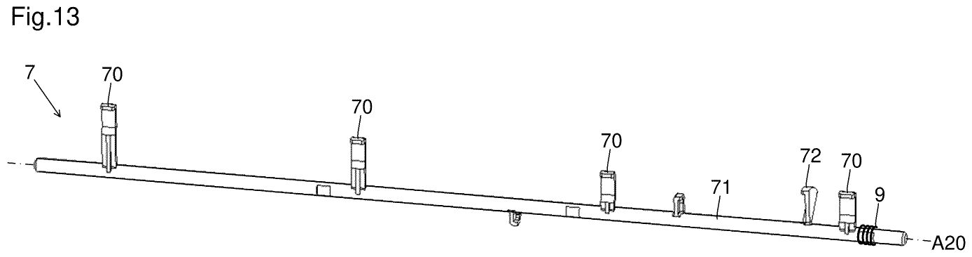

The detection mechanism 50 includes a first actuator 6 as shown in FIG. 12. The detection mechanism 50 also includes a second actuator 7 as shown in FIG. 13. For example, each of the first actuator 6 and the second actuator 7 is a resin molded product.

### Configuration of First Actuators

The first actuators 6 are allocated to the containers 2, respectively. Hence, a plurality of (four) first actuators 6 are provided. The first actuators 6 correspond to the colors of cyan, magenta, yellow and black.

The configurations of the first actuators 6 are the same as each other. Hence, in FIGS. 10 and 11, only one first actuator 6 is shown.

The first actuators 6 are disposed in a lower part inside the main body 1. Each of the first actuators 6 is disposed to be connectable to the corresponding container 2. Each of the first actuators 6 is supported to be turnable around a first axis A10 independently of each other with respect to the main body 1. The first axis A10 is an axis extending in the forward/backward direction (X direction). In other words, the first axis A10 is parallel to the outer cover axis A1.

Each of the first actuators 6 includes an axis portion 61. The axis portion 61 is disposed on the first axis A10, and extends in the axial direction of the first axis A10. In other words, the axis portion 61 extends in the forward/backward direction (X direction). In the main body 1, support holes (not shown) are provided. The axis portions 61 are fitted into the support holes in the main body 1. The axis portions 61 are slidable around the first axis A10 relative to the support holes into which the axis portions 61 are fitted. In other words, each of the first actuators 6 can be turned with the first axis A10 serving as a support point.

Each of the first actuators 6 includes a container contact portion 62. The container contact portion 62 is provided integrally with the axis portion 61. The container contact portion 62 extends in the radial direction of a circle about the first axis A10 when viewed in the axial direction (that is, the forward/backward direction) of the first axis A10.

Each of the first actuators 6 includes a first pressing portion 60. The first pressing portion 60 is provided integrally with the axis portion 61. The first pressing portion 60 extends in the radial direction of a circle about the first axis A10 when viewed in the axial direction of the first axis A10. However, the first pressing portion 60 extends in a direction different from the direction of extension of the container contact portion 62.

Each of the first actuators 6 is turned around the first axis A10 to be displaceable between a first non-fitting position and a first fitting position. The position of the first actuator 6 shown in FIG. 10 is the first non-fitting position. The position of the first actuator 6 shown in FIG. 11 is the first fitting position.

Each of the first actuators 6 is held in the first non-fitting position (see FIG. 10) when the corresponding container 2 is not fitted inside the main body 1. Each of the first actuators 6 causes the container contact portion 62 to protrude toward a fitting space in the corresponding container 2 when the corresponding container 2 is not fitted inside the main body 1.

In a state where each of the containers 2 is fitted inside the fitting region 3A of the corresponding outer cover 3, the outer cover 3 reaches the closed position from the open position, and thus the container 2 is fitted into the main body 1 (into the fitting space thereof). Then, each of the containers 2 is fitted into the main body 1 to make direct contact with the container contact portion 62 of the corresponding first actuator 6, and thereby presses the corresponding first actuator 6.

Each of the first actuators 6 is pressed by the corresponding container 2 to turn around the first axis A10. In other words, the first pressing portion 60 of the first actuator 6 is displaced around the first axis A10. In this way, the first actuator 6 is displaced from the first non-fitting position toward the first fitting position. When the corresponding container 2 is fitted inside the main body 1, the first actuator 6 is held in the first fitting position (see FIG. 11).

Here, the detection mechanism 50 includes a first biasing member 8 (see FIG. 12). The first biasing member 8 is, for example, a torsion coil spring. However, a different type of spring (such as a plate spring) from the torsion coil spring may be used as the first biasing member 8.

The first biasing members 8 are allocated to the first actuators 6, respectively. In other words, the first biasing members 8 are allocated to the containers 2, respectively. Hence, a plurality of (four) first biasing members 8 are provided.

Each of the first biasing members 8 is disposed on the axis portion 61 of the corresponding first actuator 6. One arm of the first biasing member 8 engages with the corresponding first actuator 6. The other arm of the first biasing member 8 engages with a member (not shown) disposed inside the main body 1. The first biasing member 8 biases the first actuator 6 in a direction from the first fitting position toward the first non-fitting position.

When the corresponding container 2 is not fitted inside the main body 1, the biasing force of the corresponding first biasing member 8 restricts the displacement of the first actuator 6 from the first non-fitting position to the first fitting position. In this way, when the corresponding container 2 is not fitted inside the main body 1, the first actuator 6 is held in the first non-fitting position (see FIG. 10).

The corresponding container 2 makes contact with and presses the first actuator 6, and thus the first actuator 6 is turned around the first axis A10 against the biasing force of the corresponding first biasing member 8. Here, the first actuator 6 is displaced from the first non-fitting position toward the first fitting position. Then, the first actuator 6 reaches the first fitting position.

When the corresponding container 2 is fitted inside the main body 1, the displacement of the first actuator 6 from the first fitting position to the first non-fitting position is restricted. In this way, when the corresponding container 2 is fitted inside the main body 1, the first actuator 6 is held in the first fitting position (see FIG. 11).

### Configuration of Second Actuator

The second actuator 7 is disposed in a lower part inside the main body 1. The second actuator 7 is disposed to be connectable to each of the first actuators 6. The second actuator 7 is supported to be turnable around a second axis A20 with respect to the main body 1. The second axis A20 is an axis extending in the forward/backward direction (X direction). In other words, the second axis A20 is parallel to the first axis A10.

The second actuator 7 includes an axis portion 71. The axis portion 71 is disposed on the second axis A20, and extends in the axial direction of the second axis A20. In other words, the axis portion 71 extends in the forward/backward direction (X direction). In the main body 1, a support hole (not shown) is provided. The axis portion 71 is fitted into the support hole. The axis portion 71 is slidable around the second axis A20 relative to the support hole into which the axis portion 71 is fitted. In other words, the second actuator 7 can be turned with the second axis A20 serving as a support point.

The second actuator 7 includes a detected portion 72. The detected portion 72 is provided integrally with the axis portion 71. The detected portion 72 is substantially formed in the shape of a fan about the second axis A20 when viewed in the axial direction of the second axis A20 (that is, the forward/backward direction).

The second actuator 7 includes second pressing portions 70. The second pressing portions 70 are formed integrally with the axis portion 71. The second pressing portion 70 extends in the radial direction of a circle about the second axis A20 when viewed in the axial direction of the second axis A20.

The second pressing portions 70 are allocated to the first actuators 6, respectively. In other words, the second pressing portions 70 are allocated to the containers 2, respectively. Hence, a plurality of (four, that is, the same number as the first actuators 6) second pressing portions 70 are provided.

Each of the second pressing portions 70 is disposed on the displacement locus of the first pressing portion 60 of the corresponding first actuator 6 when viewed in the axial direction of the second axis A20. In other words, the second pressing portion 70 is disposed to be connectable to the first pressing portion 60 of the corresponding first actuator 6 when viewed in the axial direction of the second axis A20.

The second actuator 7 is turned around the second axis A20 to be displaceable between a second non-fitting position and a second fitting position. The position of the second actuator 7 shown in FIG. 10 is the second non-fitting position. The position of the second actuator 7 shown in FIG. 11 is the second fitting position.

When the second actuator 7 is in the second non-fitting position, the detection region of the detection unit 5 (optical path between the light emission portion and the light reception portion) is light-shielded by the detected portion 72. On the other hand, when the second actuator 7 is in the second fitting position, the detection region of the detection unit 5 is opened (that is, the detection region of the detection unit 5 is not light-shielded). In this way, the detection unit 5 changes its output value depending on whether the second actuator 7 is in the second non-fitting position or in the second fitting position.

Here, the detection mechanism 50 includes a second biasing member 9 (see FIG. 13). The second biasing member 9 is, for example, a torsion coil spring. However, a different type of spring (such as a plate spring) from the torsion coil spring may be used as the second biasing member 9.

The second biasing member 9 is disposed on the axis portion 71 of the second actuator 7. One arm of the second biasing member 9 engages with the second actuator 7. The other arm of the second biasing member 9 engages with a member (not shown) disposed inside the main body 1. The second biasing member 9 biases the second actuator 7 from the second non-fitting position toward the second fitting position.

### Behavior of Actuators

In a state where each of the first actuators 6 is in the first non-fitting position, the first actuator 6 presses, by the biasing force of the corresponding first biasing member 8, the second actuator 7 against the biasing force of the second biasing member 9 in a direction from the second fitting position toward the second non-fitting position. Specifically, in the state where each of the first actuators 6 is in the first non-fitting position, the first actuator 6 brings the first pressing portion 60 into contact with the corresponding second pressing portion 70 to press the second pressing portion 70 with the first pressing portion 60 in a direction against the biasing force of the second biasing member 9.

In this way, in the state where each of the first actuators 6 is in the first non-fitting position, the displacement of the second actuator 7 from the second non-fitting position to the second fitting position is restricted. In other words, in the state where each of the first actuators 6 is in the first non-fitting position, the second actuator 7 remains in the second non-fitting position. In this state, the light-shielding of the detection region in the detection unit 5 is maintained by the detected portion 72 in the second actuator 7.

In a state where each of the first actuators 6 is in the first fitting position, the first actuator 6 releases the pressing of the corresponding second actuator 7 in the direction from the second fitting position toward the second non-fitting position. The first actuators 6 are supported to be turnable independently of each other. Hence, it is likely that even when a certain first actuator 6 releases the pressing of the second actuator 7, another first actuator 6 continues to press the second actuator 7.

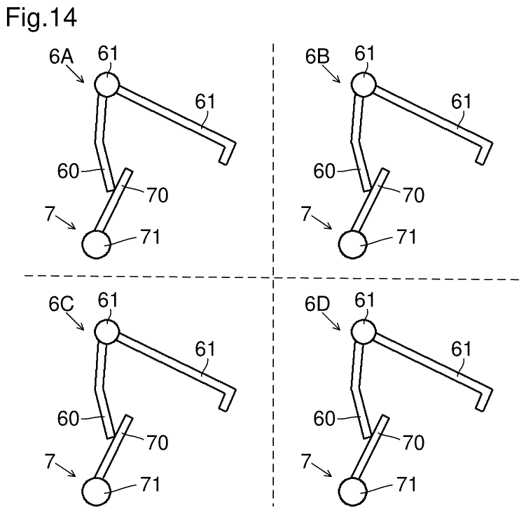

Here, the biasing force of one of the first biasing members 8 is greater than the biasing force of the second biasing member 9. Hence, the second actuator 7 behaves as follows. A specific description will be given below with reference to FIGS. 14 to 18.

In the following description, in order to distinguish between a plurality of (four) containers 2, for convenience, the symbols of the containers 2 are suffixed with symbols A, B, C and D, respectively. The symbol of the first actuator 6 corresponding to the container 2A is suffixed with a symbol A, the symbol of the first actuator 6 corresponding to the container 2B is suffixed with a symbol B, the symbol of the first actuator 6 corresponding to the container 2C is suffixed with a symbol C and the symbol of the first actuator 6 corresponding to the container 2D is suffixed with a symbol D. In FIGS. 14 to 18 referenced in the following description, the detection unit 5 and the detected portion 72 are omitted.

1. Case where All Containers 2 are not Fitted

When all the containers 2A to 2D are not fitted inside the main body 1, a state shown in FIG. 14 is reached. In other words, all the first actuators 6A to 6D are held in the first non-fitting position.

In this case, the second actuator 7 is pressed by the biasing forces of the four first biasing members 8 which are greater than the biasing force of the second biasing member 9 in the direction from the second fitting position toward the second non-fitting position. In this way, the second actuator 7 is held in the second non-fitting position.

In this case, the detection region of the detection unit 5 is light-shielded by the detected portion 72 of the second actuator 7 (see FIG. 10). Here, the control unit CON detects, based on the output value of the detection unit 5, that at least one of the containers 2 are not fitted inside the main body 1. Then, for example, the control unit CON displays, on the operation panel, a message indicting that any one of the containers 2 is not fitted.

2. Case where Three of Containers 2 are not fitted

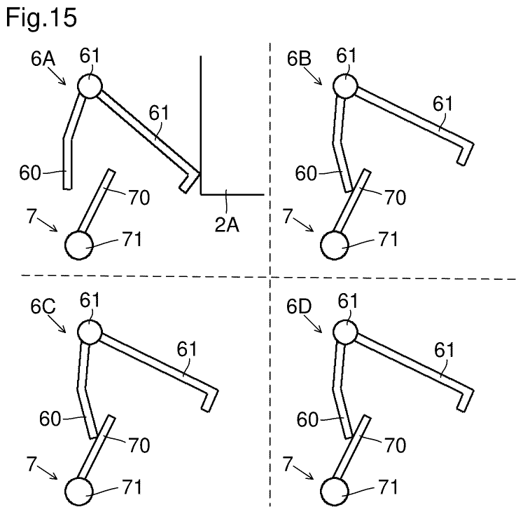

When the container 2A is fitted inside the main body 1, and the containers 2B to 2D are not fitted inside the main body 1, a state shown in FIG. 15 is reached. In other words, the first actuator 6A is held in the first fitting position. The first actuators 6B to 6D are held in the first non-fitting position.

In this way, the pressing of the second actuator 7 in the direction from the second fitting position toward the second non-fitting position performed by the first actuator 6A is released. Each of the first actuators 6B to 6D continues to press, by the biasing force of the corresponding first biasing member 8, the second actuator 7 in the direction from the second fitting position toward the second non-fitting position.

In this case, the number of first actuators 6 which press the second actuator 7 in the direction from the second fitting position toward the second non-fitting position is reduced to three. However, the biasing force of one of the first biasing members 8 is greater than the biasing force of the second biasing member 9. Hence, even when the number of first actuators 6 which press the second actuator 7 in the direction from the second fitting position toward the second non-fitting position is reduced to three, the second actuator 7 is held in the second non-fitting position. In other words, the displacement of the second actuator 7 from the second non-fitting position to the second fitting position is restricted. The detection region of the detection unit 5 continues to be light-shielded by the detected portion 72 of the second actuator 7.

3. Case where Two of Containers 2 are not Fitted

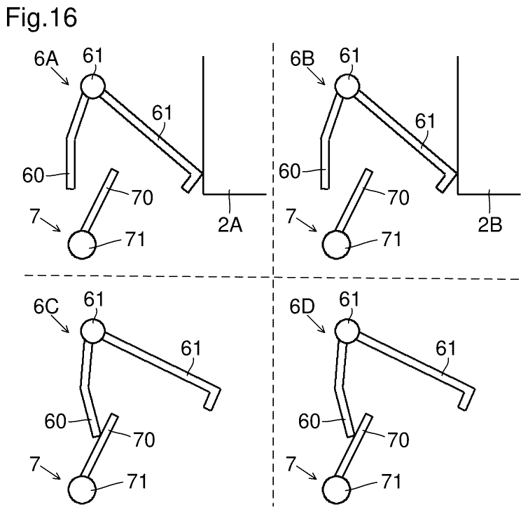

When the containers 2A and 2B are fitted inside the main body 1, and the containers 2C and 2D are not fitted inside the main body 1, a state shown in FIG. 16 is reached. In other words, the first actuators 6A and 6B are held in the first fitting position. The first actuators 6C and 6D are held in the first non-fitting position.

In this way, the pressing of the second actuator 7 in the direction from the second fitting position toward the second non-fitting position performed by the first actuators 6A and 6B is released. Each of the first actuators 6C and 6D continues to press, by the biasing force of the corresponding first biasing member 8, the second actuator 7 in the direction from the second fitting position toward the second non-fitting position.

In this case, the number of first actuators 6 which press the second actuator 7 in the direction from the second fitting position toward the second non-fitting position is reduced to two. However, the biasing force of one of the first biasing members 8 is greater than the biasing force of the second biasing member 9. Hence, even when the number of first actuators 6 which press the second actuator 7 in the direction from the second fitting position toward the second non-fitting position is reduced to two, the second actuator 7 is held in the second non-fitting position. In other words, the displacement of the second actuator 7 from the second non-fitting position to the second fitting position is restricted. The detection region of the detection unit 5 continues to be light-shielded by the detected portion 72 of the second actuator 7.

4. Case where One of Containers 2 is not Fitted

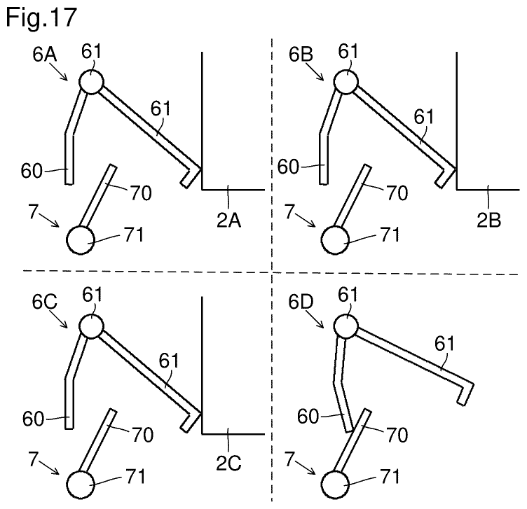

When the containers 2A to 2C are fitted inside the main body 1, and the container 2D is not fitted inside the main body 1, a state shown in FIG. 17 is reached. In other words, the first actuators 6A to 6C are held in the first fitting position. The first actuator 6 corresponding to the container 2D is held in the first non-fitting position.

In this way, the pressing of the second actuator 7 in the direction from the second fitting position toward the second non-fitting position performed by the first actuators 6A to 6C is released. The first actuator 6D continues to press, by the biasing force of the corresponding first biasing member 8, the second actuator 7 in the direction from the second fitting position toward the second non-fitting position.

In this case, the number of first actuators 6 which press the second actuator 7 in the direction from the second fitting position toward the second non-fitting position is reduced to one. However, the biasing force of one of the first biasing members 8 is greater than the biasing force of the second biasing member 9. Hence, even when the number of first actuators 6 which press the second actuator 7 in the direction from the second fitting position toward the second non-fitting position is reduced to one, the second actuator 7 is held in the second non-fitting position. In other words, the displacement of the second actuator 7 from the second non-fitting position to the second fitting position is restricted. The detection region of the detection unit 5 continues to be light-shielded by the detected portion 72 of the second actuator 7.

5. Case where All Containers 2 are Fitted

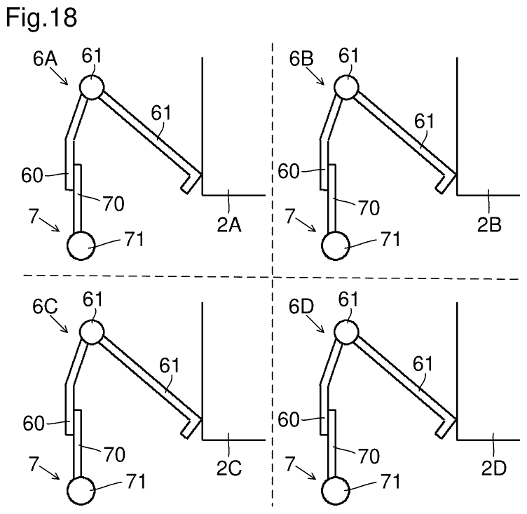

When all the containers 2A to 2D are fitted inside the main body 1, a state shown in FIG. 18 is reached. In other words, all the first actuators 6A to 6D are held in the first fitting position.

In this case, the second actuator 7 is not pressed in the direction from the second fitting position toward the second non-fitting position. In this way, the second actuator 7 is held by the biasing force of the second biasing member 9 in the second fitting position.

In this case, the detection region of the detection unit 5 is not light-shielded by the detected portion 72 of the second actuator 7 (see FIG. 11). Here, the control unit CON detects, based on the output value of the detection unit 5, that all the containers 2 are fitted inside the main body 1. In other words, the control unit CON allows the image forming apparatus 100 to perform printing.

In the present embodiment, in the configuration described above, when all the containers 2 are fitted inside the main body 1, the second actuator 7 is displaced from the second non-fitting position to the second fitting position, and thus the output value of the detection unit 5 is switched to the first level value. On the other hand, when any one of the containers 2 is not fitted inside the main body 1, the second actuator 7 is not displaced from the second non-fitting position, and thus the output value of the detection unit 5 is maintained to be the second level value. In this way, it is possible to suppress the occurrence of a problem in which printing is performed without any one of the containers 2 being fitted.

Here, in the present embodiment, when any one of the containers 2 is fitted into the main body 1, the container 2 fitted inside the main body 1 makes direct contact with the first actuator 6 corresponding to the container 2 to press the first actuator 6. In this way, the first actuator 6 corresponding to the container 2 fitted inside the main body 1 is turned around the first axis A10 to be displaced from the first non-fitting position to the first fitting position.

Furthermore, in the present embodiment, the biasing force of one of the first biasing members 8 is greater than the biasing force of the second biasing member 9. In this way, unless all the first actuators 6 are displaced from the second non-fitting position to the first fitting position, the second actuator 7 is not displaced from the second non-fitting position to the second fitting position.

This configuration is convenient for the user because when the containers 2 are fitted into the main body 1, and then all the containers 2 have been fitted, the output value of the detection unit 5 is automatically switched to the first level value. In other words, it is not necessary to perform an operation which corresponds to a conventional lever operation. Conventionally, a lever needs to be operated each time a container is fitted, and this is cumbersome for the user.

In the present embodiment, in the configuration where a plurality of containers 2 are fitted into the main body 1, it is possible to reliably detect whether all the containers 2 are fitted inside the main body 1 without increasing the number of steps which need to be performed by the user when the containers 2 are fitted.

In the present embodiment, in a state where the container 2 is fitted inside the fitting region 3A in the outer cover 3, the outer cover 3 is closed, and thus the container 2 can be fitted into the main body 1. In this way, it is easy to fit the container 2.

The embodiment disclosed herein should be considered to be illustrative in all respects and not restrictive. The scope of the present disclosure is indicated not by the description of the embodiment but by the scope of claims, and furthermore, meanings equivalent to the scope of claims and all changes in the scope are included therein.

What is claimed is:

1. An image forming apparatus comprising:
a main body that includes a printing unit;
a plurality of containers each of which is individually removably fitted into the main body and stores a toner used in printing performed in the printing unit;
a plurality of first actuators
which are supported to be turnable around a first axis independently of each other with respect to the main body, and are respectively allocated to the plurality of containers, and
each of which makes contact with, when a corresponding one of the containers is fitted into the main body, the corresponding container, and turns around the first axis to be displaced from a first non-fitting position to a first fitting position;
a second actuator that
is supported to be turnable around a second axis parallel to the first axis with respect to the main body, and
turns around the second axis to be displaceable from a second non-fitting position to a second fitting position;
a plurality of first biasing members
which are respectively allocated to the plurality of first actuators, and
each of which biases a corresponding one of the first actuators in a direction from the first fitting position toward the first non-fitting position;
a second biasing member that biases the second actuator in a direction from the second non-fitting position toward the second fitting position; and
a detection unit that changes an output value depending on whether the second actuator is in the second non-fitting position or in the second fitting position,
wherein in a state where each of the plurality of first actuators is in the first non-fitting position, the first actuator presses, by a biasing force of a corresponding one of the first biasing members, the second actuator against a biasing force of the second biasing member in a direction from the second fitting position toward the second non-fitting position to cause the second actuator to remain in the second non-fitting position,
in a state where each of the plurality of first actuators is in the first fitting position, the first actuator releases the pressing of the second actuator in the direction from the second fitting position toward the second non-fitting position and
a biasing force of one of the plurality of first biasing members is greater than the biasing force of the second biasing member.

2. The image forming apparatus according to claim 1, further comprising:
a plurality of covers
which are respectively allocated to the plurality of containers, and each of which
is supported to be turnable around a predetermined axis parallel to the first axis with respect to the main body, and
turns around the predetermined axis to be displaceable between a closed position where an interior of the main body is covered from an outer side and an open position where the interior of the main body is exposed,
wherein each of the plurality of covers
includes a fitting region on an inner side of the main body, and
reaches the closed position from the open position in a state where a corresponding one of the containers is fitted inside the fitting region to fit the corresponding container into the main body, and
in a state where each of the plurality of containers is fitted inside the fitting region of a corresponding one of the covers, the corresponding cover reaches the closed position from the open position to press a corresponding one of the first actuators against a biasing force of the first biasing member in a direction from the first non-fitting position to the first fitting position.
